(19) United States
(12) Patent Application Publication
(10) Pub. No.: US 2026/0356151 A1
(43) Pub. Date: Nov. 12, 2026

(54) SYSTEMS AND METHODS FOR CONTROLLING INTERACTIONS BETWEEN A VEHICLE AND A ROAD SURFACE

(71) Applicant: ClearMotion, Inc., Billerica, MA (US)

(72) Inventors: Yu Jiang, Wellesley, MA (US); Marco Giovanardi, Melrose, MA (US); Nikolaos Karavas, Cambridge, MA (US); Christian Steinmann, Heidelberg (DE); William Graves, Somerville, MA (US)

(73) Assignee: ClearMotion, Inc., Billerica, MA (US)

(21) Appl. No.: 19/121,701

(22) PCT Filed: Oct. 17, 2023
(86) PCT No.: PCT/US2023/077102

§ 371 Date: Apr. 16, 2025

Related U.S. Application Data
(60) Provisional application No. 63/417,141, filed on Oct. 18, 2022.
(60) Provisional application No. 63/456,668, filed on Apr. 3, 2023.

(51) Int. Cl. B60G 17/0165; B60W 10/18; B60W 10/22

(52) U.S. Cl. CPC B60G 17/0165; B60W 10/18; B60W 10/22; B60G 2400/204; B60G 2400/821; B60G 2400/91; B60W 2520/10; B60W 2552/35; B60W 2556/65

(57) ABSTRACT

Vehicles traveling on a road surface may encounter a variety of road surface features and characteristics. Encounters with certain road surface features may lead to undesirable outcomes, including discomfort for passengers, potential damage to vehicle components, and safety concerns. Methods and apparatus are disclosed for detecting and characterizing such features and using onboard systems to mitigate their effect. These methods and apparatus also include using information about the interaction of a front wheel with a feature to implement a control strategy that mitigates the effects of the interaction of the rear wheel of the vehicle, with the same feature. Additionally, the disclosure introduces methods and equipment for collecting information about and assessing certain road surface characteristics, such as friction parameters.

### RELATED APPLICATIONS

This application claims the benefit of priority under 35 U.S.C. § 119 (e) of U.S. application Ser. No. 63/417,141, filed Oct. 18, 2022, and U.S. application Ser. No. 63/456,668, filed Apr. 3, 2023, the disclosures of which are incorporated herein by reference in their entirety.

### FIELD

Disclosed embodiments are related to the control of the motion of a vehicle as it travels on a road surface.

### BACKGROUND

Roads designed for vehicle travel may contain multiple discrete features, or anomalies, such as, for example, potholes, speed bumps, manhole covers, road surface cracks, etc. and/or distributed surface characteristics such as various coefficients of friction and various road surface profiles. When a vehicle interacts with such features or surface characteristics, the vehicle and/or the occupants of the vehicle may be exposed to adverse effects induced by that interaction. For example, undesirable vertical motion may be transmitted to the vehicle body, thereby resulting in a degraded experience for an occupant of the vehicle. Additionally, interacting with such features may cause damage to components of the vehicle (e.g., by blowing out a tire, bending or deforming a rim, generally increasing wear and tear on suspension components, etc.) or affect vehicle safety. There are several vehicle motion control systems, such as the braking system, active or semi-active suspension systems, driver assistance systems, etc., that may be controlled proactively prior to traversing such road features or road surfaces in order to prepare the vehicle accordingly and mitigate one or more of these adverse effects.

### SUMMARY

In some aspects, the techniques described herein relate to operating a vehicle, including: interacting with a negative road feature with a first wheel of the vehicle, during a first interaction; during that interaction, receiving data from at least one sensor on-board the vehicle; based on the data, determining a characteristic of the negative road feature; based on the characteristic, developing a control strategy, for a second wheel, to minimize the amount of penetration into the negative road feature with a second wheel of the vehicle; interacting with the negative road feature with the second wheel of the vehicle; and during a second interaction, implementing the second-wheel control strategy. In some embodiments, the negative road feature may be a pothole, the characteristic of the negative road feature may be a length of the pothole or a depth of the pothole, the second-wheel control strategy may include the use of an active suspension system, a semi-active suspension system, a steering system, or a braking system, and/or the second-wheel control strategy may depend at least partially on a value of a state parameter of the vehicle (e.g. the speed of the vehicle). In some embodiments, the vehicle may further include a third wheel and a fourth wheels, where the second-wheel control strategy may include initiating a warp vertical wheel force pattern among the four wheels and/or bouncing the second wheel at a predetermined frequency (e.g. at the wheel-hop frequency of the second wheel.

As used herein, when referring to a pair of vehicle wheels that may encounter a specific road feature or travel over effectively the same section of road surface, “front wheel” or “first wheel” refers to the wheel that encounters the road feature or travels over the section of road surface before the “rear wheel” or “second wheel.” For example, in a vehicle with more than four wheels, the first or front wheel may be any leading wheel, and the second or rear wheel may be any trailing wheel that encounters or interacts with a given road feature or a given segment of road surface.

In some aspects, the techniques described herein relate to operating a first vehicle, including: receiving information about a first interaction between a wheel of a second vehicle and a negative road feature; based on the information, determining a characteristic of the negative road feature; based on the characteristic, developing a wheel control strategy to minimize the amount of penetration into the negative road feature with a wheel of the first vehicle; interacting with the negative road feature with the wheel of the first vehicle; and during the second interaction, implementing the wheel control strategy. In some embodiments the first vehicle and the second vehicle may be the same vehicle, the negative road feature may be a pothole, the characteristic of the negative road feature may be the length or the depth of the pothole, the second-wheel control strategy may include the use of an active suspension system, a semi-active suspension system, a steering system, or a braking system, the second-wheel control strategy may depend at least partially on a value of a state parameter of the vehicle (e.g. the speed of the vehicle). In some embodiments the first vehicle may include a total of four wheels where the second-wheel control strategy may include initiating a warp vertical wheel force pattern among the four wheels or bouncing the second wheel at a predetermined frequency (e.g. at the wheel-hop frequency).

In some aspects, the techniques described herein relate to operating a first vehicle, including: traveling along a road surface with the vehicle wherein the road surface includes a feature; receiving information about the feature with a controller; determining when a first wheel of the vehicle will reach the feature; determining a force input profile to reduce a normal force on the first wheel when the first wheel reaches the feature, where the first force input profile is configured to improve at least occupant comfort, vehicle safety, and/or vehicle drivability. Information about the feature may be collected during one or more previous drives of the same vehicle, during previous drives of a multiplicity of vehicles, from sensor signals on-board the first vehicle. In some embodiments, information about a vehicle may be received by a controller in the first vehicle from sensors on-board the first vehicle. For example, sensors on-board the first vehicle may receive information about a feature when a first wheel of the first vehicle interacts with the feature, which may then be used to mitigate the adverse effects of an interaction between a second wheel of the first vehicle and the same feature.

In some aspects, the techniques described herein relate to operating a first vehicle, including: traveling along the first road surface with the first vehicle; modifying a normal force on at least the first tire of the first vehicle according to a predetermined pattern; with an on-board sensor, determining a variation in angular wheel speed of the first wheel as a function of the normal force; comparing the variation in angular wheel speed of the first wheel as a function of the normal load with previously obtained reference data; and based on the comparison, determining the value of the parameter. In some embodiments, the parameter may be the coefficient of friction between the first tire and the first road surface. In some embodiments, the reference data may be a variation in angular wheel speed of a second wheel as a function of a normal load, the reference data may be a previously obtained variation in angular wheel speed of the first wheel as a function of a normal load, the normal force may be modified by using an active suspension actuator interposed between the first the first wheel a body of the first vehicle, and/or the normal force may be varied at a predetermined frequency (e.g. effectively the wheel-hop frequency of the first wheel).

In some aspects, the techniques described herein relate to operating a first vehicle, including: traveling along a road surface with the vehicle; anticipating an interaction between a wheel of the vehicle and a positive feature, wherein a height of the feature is greater that an available suspension travel or greater than a desirable suspension travel; planning a trajectory that limits suspension travel to the available or desirable suspension travel within limits of available actuator force while maximizing a level of comfort for one or more vehicle occupants; and commanding an actuator to move a portion of the vehicle, wherein at least the portion of the vehicle is commanded to follow the planned trajectory.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF FIGURES

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 illustrates major instances and phases during which a vehicle interacts with or traverses a road feature with a front and a rear wheel.

FIG. 2 illustrates the twist mitigation strategy for the rear wheel.

FIG. 3 illustrates a block diagram of the rear wheel preview controller.

FIG. 4 illustrates a possible implementation of a soft saturation algorithm.

FIG. 5 illustrates a wheel encountering a road event.

FIG. 6 illustrates time traces of wheel acceleration and longitudinal acceleration for a vehicle traversing an event first on the front wheel and then the rear wheel.

FIG. 7 illustrates a schematic layout of a wheel.

FIG. 8 illustrates a typical carpet plot for longitudinal force on a tire as a function of vertical force and longitudinal slip.

FIG. 9 shows the difference in wheel speed and road surface friction for a simulated vehicle while energizing the wheels in a repeated pattern.

FIG. 10 shows the calculated relationship of peak-to-peak wheel speed difference to road surface friction for a simulated vehicle.

FIG. 11 shows the relationship between peak-to-peak wheel spin acceleration and road surface friction for a vehicle with additional tire loading applied in a slow warp pattern.

FIG. 12 illustrates a schematic representation of a wheel and suspension about to traverse a positive event.

FIG. 13 illustrates the schematic representation of a wheel and suspension about to traverse a positive event according to a trajectory plan.

FIG. 14 illustrates the schematic representation of a wheel and suspension while traversing a positive event.

FIG. 15 is a schematic illustration of an embodiment of a vehicle, including a vehicle control system and vehicle sensors.

### DETAILED DESCRIPTION

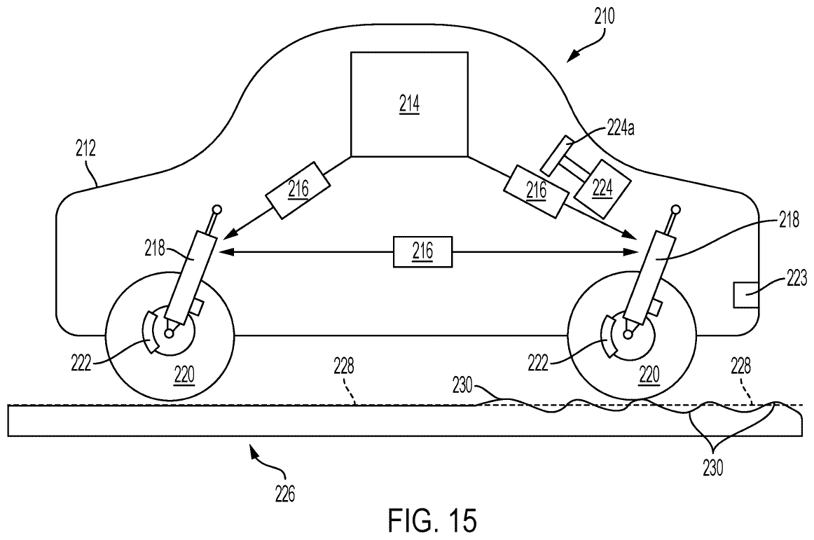

In some embodiments, a cloud-based crowdsourcing system, with a database of known road features, that communicates with one or more microprocessors on board a vehicle, may inform one or more control systems in a vehicle about an upcoming or anticipated interaction with a road feature (e.g., a pothole, a manhole cover, a bump), i.e. road event. Alternatively or additionally, as illustrated in FIG. 15, a sensor-based look-ahead system (such as systems based on a camera, LiDAR, RADAR, or similar non-contact look-ahead sensors 223) may be used. However, either of those systems may not be readily available or effective. Alternatively or additionally, information from one or more on-board motion sensors 223a may be exploited in real-time, when a front wheel (and associated front axle) interacts with, or traverses, a given road feature. Such information may be provided to a vehicle control system about an upcoming or anticipated event (e.g. an interaction of another portion of a vehicle (e.g. a rear wheel) with the same road feature). The vehicle control system may then use one or more actuators to mitigate the effect on the vehicle, of the interaction of the rear wheel or axle with the road feature. By using such information from on-board motion sensors, in some embodiments and under certain operating conditions, there may be reduced reliance or no reliance on a look-ahead system.

In order to provide these benefits, following procedures may be implemented. First, a detection method may be utilized to predict the behavior of the vehicle during an anticipated interaction with a road feature at a rear wheel of a vehicle, based on information gathered during the interaction of a front wheel with the same road feature. The method may include determining certain characteristics of the feature, such for example, dimensions, and/or shape a feature based on information gathered during the front-wheel interaction. Next, an actuation system may be utilized that uses such information. Actuation systems may include but are not limited to active suspension actuators, active roll actuators, braking actuators, steering actuators, semi-active suspension actuators, or others. Finally, a method for commanding the actuation systems may be used in order to maximize the benefit for the vehicle and/or the occupant(s) derived at least partially from the a priori information. Such methods may be specific to each particular actuation system and/or to each type of feature or may share common elements.

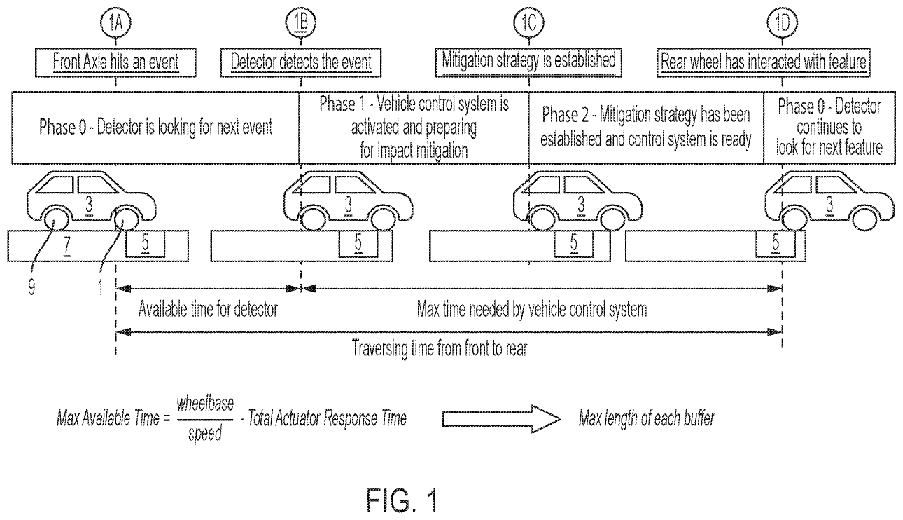

In some embodiments, there may be discrete steps that occur as a vehicle traverses or interacts with a road feature. Referring to FIG. 1, the first step 1A may occur when a front wheel 1 of vehicle 3 reaches or interacts with a feature 5, e.g., a pothole, in road surface 7. During Phase 0, an in-vehicle detector, operating continuously or intermittently, may receive and analyze sensor data that may be segmented into buffers of a certain size. Phase 0 may extend beyond and occur concurrently with the Phase 1 and Phase 2. During phase 0, data may be obtained or received from motion sensors such as, e.g. acceleration, velocity or position sensors mounted, e.g., on or near the front axle and/or on the vehicle body, or from other sensors indicative of the vehicle motion or the motion of vehicle components, such as for example a wheel 1 or part of the associated un-sprung mass. In the embodiment illustrated in FIG. 1, at step 1B, the road feature has been detected, Phase 1 begins, and a vehicle control system (e.g., central controller, braking system controller, active or semi-active suspension controller, driver assistance system controller, a propulsion system controller, etc.) may be triggered to develop or select a mitigation strategy in preparation, e.g., for a rear wheel 9 interaction or traversal of the road feature 5. A mitigation strategy may include controlling an actuator and/or modifying operating parameters of one or more control systems of the vehicle. For example, in the case of an active suspension system, a mitigation strategy may involve activating certain suspension forces or altering control parameters such as damping coefficients. Due to physical system limitations (e.g., limited actuator bandwidth) a mitigation strategy may require time before it can be fully implemented (at time step 1C). After time step 1C the control system may be prepared for the rear-wheel interaction with or traversal of the road feature 5. At time step 1D, the rear wheel has interacted with or traversed the feature, and the adverse effect from the event may have been mitigated.

The duration of Phase 1 may depend on the vehicle control system and determines how much time is available, after the detector has detected that an interaction with a feature has occurred at the front wheel, to categorize and classify the event at the front wheel, so that the mitigation strategy can take effect prior to the rear wheel reaching the event. Without wishing to be bound by theory, the duration from time step 1A to time step 1D is the traversing time from front to rear wheel and may be calculated by the following formula:

$$FrontToRearTraversingDuration = \frac{Wheelbase}{VehicleSpeed}$$

Thus, the maximum available time for the detector may be given by:

$$MaxAvailTime = \frac{Wheelbase}{VehicleSpeed} - MaxTimeForMitigation$$

where MaxTimeForMitigation may be the maximum time needed by the vehicle control system to prepare for traversal of the road event. For example, an active suspension system may require, approximately 100 ms to achieve desired force, and a vehicle's wheelbase may be 3 meters long, it would follow:

$${MaxAvailTime}_{10 m / sec} = \frac{3 m}{10 m / sec} - 0.1 sec = 200 msec$$

$${MaxAvailTime}_{20 m / sec} = \frac{3 m}{20 m / sec} - 0.1 sec = 50 msec$$

$${MaxAvailTime}_{30 m / sec} = \frac{3 m}{30 m / sec} - 0.1 sec = 0 msec$$

For each vehicle control system and mitigation strategy, there is a speed for which there may not be sufficient time for the detector to detect a road feature and to implement the mitigation strategy. However, inventors have recognized that the negative effect of traversing certain features, e.g. potholes, may be less significant at higher speeds when less time may be available for Phase 1.

The MaxAvailTime may determine the maximum length of the buffer used to segment the upcoming data. The length of the buffer may affect the detection performance in that it may be more challenging to identify a road feature within a shorter section of data than in a longer one. A certain degree of overlap between consecutive buffers may be beneficial to ensure that the vehicle response while traversing a road feature is entirely captured within the data and not only part of the response. The appropriate amount of overlap may depend on the type of road feature, as some features may generate a longer time response of the vehicle and thus more overlap between segments may be appropriate to ensure that the entire response is captured.

The data contained in each buffer may be processed using a detection algorithm, which may be implemented in a processor on-board the vehicle or may be implemented in a second vehicle or in another remote processor, for example one located in the cloud. In some embodiments, conventional approaches for anomaly detection in short time series may be used as a detection algorithm. For example, several statistical measures may be calculated to identify abrupt changes in data. These techniques have some advantages, which include low computational cost and sometimes simplicity, but may also have significant limitations. For example, conventional approaches may have several parameters which require separate tuning for each test case; their detection performance may be moderate; and they may not be easily scalable. Scalability is a desirable attribute or factor for such an application since a large library of road features may be created. In some embodiments each type or category of road feature may require a unique mitigation strategy from the same or a different vehicle control system. In addition, for a given mitigation strategy, a certain categorization of road features may be required based on their properties (e.g., classification of potholes based on their length, depth, sharpness of the edge, width and/or shape). In some embodiments, machine learning based approaches may be used for road feature detection since, despite their complexity, they may be highly scalable, modular, and may solve categorization problems. A machine learning model may be trained on a representative dataset in order to perform predictions with high confidence on an unknown dataset. In this context, a positive prediction may correspond to a road feature detection and a negative prediction to a no-detection. The training process may take place offline outside vehicle if sensor data have been previously collected and stored in an external storage device but may also occur on-board the vehicle if the data can be stored in the vehicle. A compact trained machine learning model may be deployed and used as input to the data buffers described previously. Examples for these models may include, but are not limited to, k-nearest neighbor's algorithms, support vector machine algorithms, neural networks, and others.

Detection of an upcoming road feature may benefit several vehicle control systems. In some embodiments, a mitigation strategy described here may be applied by an active suspension system in order to mitigate the effects of a single wheel negative impact event (SWNIE). As used herein, the term “SWNIE” refers to a road feature, that is comparable in size to a vehicle or smaller, that may occur on one side of the vehicle (left or right) at a given time. During a SWNIE, the road surface drops away from the vehicle before coming back toward the vehicle. Examples of such features may include, but are not limited to, potholes, manhole covers, drain grates, diagonal trenches, etc. When a vehicle wheel traverses such a road feature, that wheel may start to fall into the feature. Prior to the interaction of the wheel with the SWNIE, the suspension spring, associated with that wheel, may be compressed due to the vehicle body mass (e.g., load equivalent to approximately ¼ of vehicle weight (for a 4-wheeled vehicle) may stored in each suspension spring with a roughly even distribution of weight among the front and rear, and left and right sides of the vehicle). Because of the stored energy in the spring, the acceleration of the wheel during the penetration of the wheel into the SWNIE may be high. The stored energy in the spring may be released when the wheel becomes airborne, and the wheel may hit the edge of the road feature resulting in an adverse effect on the vehicle body, for example in the longitudinal and/or vertical direction. To mitigate the effects of such an event, a twist force may be applied by an active suspension systems at the four wheels. In a 4-wheel vehicle, a twist force may include the implementation of simultaneous or effectively simultaneous pull up and push down commands for each pair of the diagonally opposed wheels, respectively. For instance, if it is anticipated that left rear wheel a vehicle will interact with a SWNIE, then compression forces may be applied at the rear left and front right wheel, whereas, effectively simultaneously, extension forces may be applied at the rear right and front left wheels. In this manner, the rear left wheel may be prevented from falling into the SWNIE or may fall with diminished acceleration. As a result the effect on the vehicle of the impact of the left rear wheel at the far end of the SWNIE may be mitigated or eliminated.

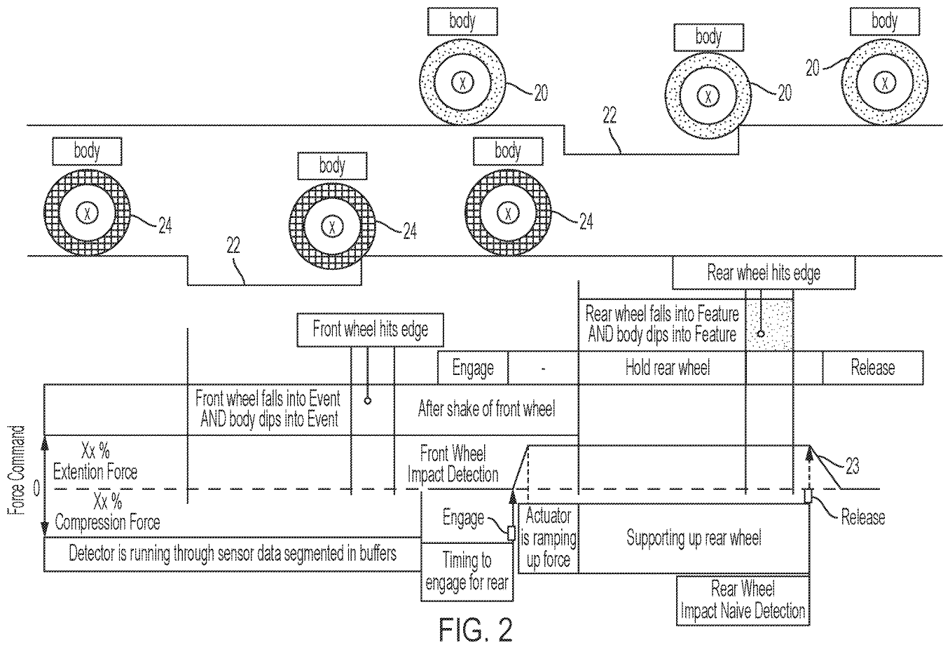

FIG. 2 illustrates a sequence of events that may occur when a vehicle's front wheel 20 interacts with or traverses a pothole 22, along with the corresponding force command 23 that may be issued to the actuator associated with the rear wheel 24 that is on the same side of the vehicle. In certain embodiments and operating conditions, a twist force may be applied following the front wheel's interaction with the pothole and the detection of the presence of the pothole by a detector. However, a delay period may be accounted to allow after-shake movement to dissipate at the front wheel 20 before twist force may applied. Inventors have recognized that such a delay may be needed to avoid extending the period during which front wheel oscillating. Once the target force command is given, there may be a lag before the actuator reaches full force. After such a mag, the mitigation may take be effective or fully effective and the rear wheel may be held up or may fall into the pothole with reduced acceleration (depending on the target force level and the force capacity of the actuator to produce a commanded or a desired force). A detector may also be used to detect the rear wheel impact. Once the back-wheel impact is detected, the controller may return the force command to zero in order to conserve energy and/or so that the system may be able to prepare to react to the next road feature. This detector may be a relatively simple detector as the impact may be anticipated within a certain time window after the front wheel interaction.

It should be noted that the information described here as being gathered on the front wheel of a vehicle may also come from outside sources, such as for example from a preceding vehicle through vehicle-to-vehicle communication, from a preceding vehicle through communication using a cloud server, or from the ego vehicle using non-contact preview sensing that is able to determine the characteristics of the event.

As used herein, the term “rear preview” refers to a method of using information from the front or leading wheel or from a sensor ahead of a trailing wheel to control actuators periodically, occasionally, or continuously at a rear or trailing wheel with a goal of improving overall body isolation from road disturbances. At a high level, it may consist of a real-time road z-estimator running at, for example, the front axle, or running based on sensor information ahead of an axle. The road z-estimate may then be used to determine an optimal feedforward or open-loop force for the rear or trailing actuators ahead of time by, for example, inverting a model of the vehicle or wheel motion response.

Because it may be calculated with advance knowledge, this force may not have some of the inherent limitations of a force determined by a feedback-only controller. For example, it may be acausally filtered, allowing control of a desired frequency range with good phase precision, whereas a feedback-only force may have undesirable effects due to the phase introduced by an equivalent real-time filter. In some embodiments, by decreasing, e.g., the effects of a rear wheel interaction with a road surface features, overall vehicle heave and pitch motion as well as roll motion may be mitigated. It should be noted that acausal filtering may require a certain duration of preview knowledge due to filter transients. At higher speeds the time between the front wheel and rear wheel interacting with a road surface feature may be short. As this time gets smaller, the frequency range over which rear wheel preview may be used to effectively control rear wheel motion may also be reduced.

In some embodiments and under certain operating conditions, one or more vehicle controllers, running on one or more microprocessors, may receive information from on-board motion sensors when a front wheel interacts with a discrete road surface feature. One or more controllers on-board the vehicle may use this information to control aspects of various vehicle systems to respond when the rear wheel interacts with the same feature.

Additionally or alternatively, in some embodiments and under certain operating conditions, one or more vehicle controllers, running on one or more microprocessors, may estimate one or more characteristics of the road surface ahead of a rear wheel by monitoring aspects the motion of the front wheel, as measured by on-board motion sensors, as the front wheel interacts with the same or effectively the same road surface. The estimation of road surface characteristics, e.g., road surface profile, coefficient of friction, road roughness, road texture, etc. as described above may occur intermittently, effectively continuously, or continuously, as the present disclosure is not limited in this respect.

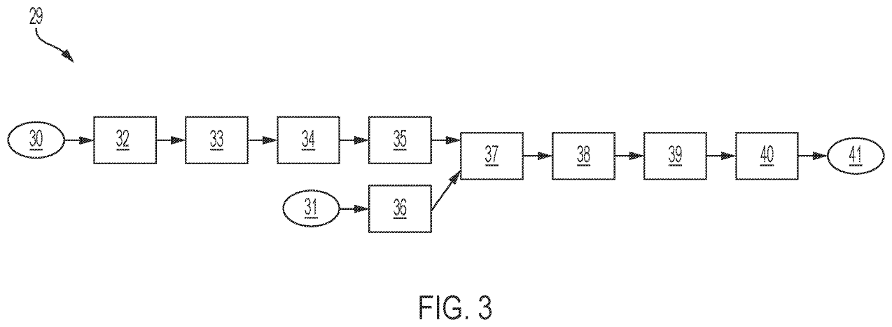

FIG. 3 is a block diagram of an embodiment of a preview controller 29 that generates a force command at block 41 for at least one actuator associated with a rear-wheel (e.g. active or semi-active suspension actuator). The preview controller 29 may receive sensor data at block 30 about the front-wheel motion, induced by the interaction of a front wheel with a portion of a road surface, and vehicle speed information at block 31. The road estimator at block 32 is configured to estimate values of parameters related to one or more aspects of the portion of the road surface based, at least in part, on information from sensors at block 30. Referring to FIG. 3, the road estimator 32 may use the available sensor information 30, e.g. z-axis sensors, to generate a real-time estimate of the road's change in position normal to the road surface, i.e. profile of the road surface under each wheel. In some embodiments of the preview controller 29, sensors may include one or more accelerometers attached to the un-sprung mass or the damper, ride height sensors, and accelerometers or an IMU attached to the vehicle body. In some embodiments, the changes in the direction normal to the nominal road surface, i.e. z-estimate, may be a rate of change or an absolute position in direction normal to the nominal road surface.

As used herein, when referring to road z-estimate it should be understood that this estimate may be a representation of the vertical road profile at least along a path in front of a wheel; this estimate may describe the vertical profile or its spatial derivatives, of a function related to the actual road profile that captures how the road interacts with the tire and wheel assembly, as the tire will envelop some road content features while following others. In some embodiments, this function may represent a path of the tire contact patch, or an abstract notion of the tire contact patch as a single point contact. In some embodiments, this function may be a road profile received by a non-contact sensor such as a Laser, Radar, or Lidar, and may be processed using a tire model to capture tire enveloping of road content. In some embodiments, the function may be accurate within a defined temporal or spatial frequency range, such as for example for features longer than the tire contact patch, or for features acquired between 0.5 Hz and 8 Hz in the time domain, or for features within another temporal or spatial frequency range.

In some embodiments of preview controller 29 may use an inverse model of at least a portion of the vehicle and its suspension to estimate one or more characteristics of the road surface. Since the estimator may be a real-time estimator, its inverse model may need to be low-pass-filtered. The low-pass filtering may introduce phase error relative to a perfect road estimator. However, such a phase error may be corrected in a later step, during the acausal filtering.

For rear wheel preview, the road one or more parameters about the road surface travelled by the two front wheels may be estimated in real time and passed to the next subsystem, the time buffer at block 33. In some embodiments, the time buffer may maintain a rolling buffer, e.g. a one-second buffer, of these road surface estimates. The length of the buffer may be a more important consideration at very low-speed driving than at higher speeds. For example, a one-second buffer may be sufficient as long as the time between front and rear driving arriving at the same spot in the road surface remains at one second or less. In a typical vehicle with wheelbase of approximately 3 meters, this may allow effective control down to vehicle speeds of 3 m/s (approximately 7 mph). The buffer length may be increased for control below that speed.

In the embodiment of FIG. 3, once a buffer of road estimates has been generated, it may be acausally filtered in block 34. The acausal filtering may consist of applying bandpass filters forward and then backward on the buffer to achieve reduced phase change over a single one-directional filtering operation. In some embodiments, this may allow the content of the road estimate (and thus force command) to be controlled within an appropriate frequency range. In some embodiments of the preview controller 29, the effective frequency range may extend from a low limit of approximately 1 to 5 Hz, depending on speed of the vehicle, to a high limit of approximately 7 to 10 Hz, depending on the accuracy of the inverse model. However, a frequency range extending between a different low limit and/or a different high limit from those indicated above may be used, as the disclosure is not so limited.

The forward- and backward-pass may be split up so that the forward-pass is an ordinary real-time filter located just after the road estimator. The backward-pass may then remain at the location shown in the diagram. In some embodiments, this arrangement may reduce the computational burden as well as avoid the transient that the forward-pass would have if applied to the buffer directly.

However, the backward-pass may still have a transient. In some embodiments, each time a new road estimate point may be added to the time buffer, the backward-pass may need to be reapplied. It may display the typical transients expected when applying a filter to the start of a signal. This may result in the newest points in the buffer not representing the ideal acausally filtered road. The transient may have a decreasing impact on older points in the buffer.

The extent of the transient may be determined mainly by the bandpass filter's lower frequency cutoff. In this way, in some embodiments, the transient may be shortened at the expense of narrowing the frequency range in which rear preview operates. The higher the vehicle speed, the shorter the time delay between front and rear axle. To keep the filter transient shorter than this time delay, the bandpass filter's low frequency limit may be adjusted as a function of speed. However, in some embodiments, above a certain speed (e.g., 45 to 60 mph) the bandpass may become so narrow that rear preview may be ineffective.

Also, in some embodiments, at block 34, a phase correction may be applied to the buffer to negate the phase introduced at the real-time road estimator.

The inverse model (e.g. transfer function) at block 35 may be used to convert the buffer of filtered road estimate to the force domain. It may use, for example, a model of the rear vehicle body and suspension, and invert that to determine the force command that would most effectively isolate the vehicle from the effects of the rear wheel interacting with the road surface. Because this inverse model may be applied to a buffer of preview information rather than processing real-time input, it may maintain a perfect or effectively perfect phase relationship.

The model itself may be a simplified quarter car model. In some embodiments, such a model may provide satisfactory accuracy up to wheel hop frequency (generally about 12 Hz). Thus the upper frequency of the acausal bandpass filters may generally be below this value (e.g., 7 to 10 Hz).

In some embodiments, if appropriate, blocks shown in FIG. 3 may be rearranged, blocks may be combined, added, and/or removed, as the disclosure is not so limited. For example, blocks 33, 34, and 35 may be combined into a single linear transformation. Such a combined transformation may use, for example, a method of applying one or multiple causal or acausal filters.

The rear delay estimate at block 36 may continuously estimate the delay between front and rear wheels. More specifically, given the longitudinal location of the rear wheel, it may calculate how long since the front axle was at that same location. Simply dividing wheelbase by speed may provide a sufficiently accurate estimate at nearly constant speeds. However, when the vehicle speed is changing speed (i.e. the car is accelerating or decelerating), that estimate may not be sufficiently accurate.

In some embodiments, the speed may be integrated to compute a continuously increasing distance value. The distance value may then be added to a rolling one-second buffer. To determine the rear delay, a search in the buffer may be performed to find the point that is a wheelbase smaller than the vehicle's current distance value. For example, if the vehicle's current distance value is 335.2 meters and the car has a wheelbase of 3 meters, a search may be performed for 335.2−3=332.2 meters in the buffer. If that point is found to have occurred in the buffer 0.35 seconds ago, the front-to-rear delay may be determined to be 0.35 seconds. Driving below 3 m/s may require a buffer longer than one second to be able to continue using preview. In the interpolation block 37 where the delay estimate is used it to pick out which point in the force command buffer should be used at a current timestep.

In some embodiments, the filter 38 may be used to remove spurious measurements that may be received from motions sensors that are not induced by the road surface but rather by vehicle related artifacts, e.g. wheel imbalance, loose or worn bushings, and engine imbalance. If the effects of such spurious signals are not removed or mitigated, the commanded force may induce unnecessary motion at the back of the vehicle. For example, a wheel imbalance may introduce suspension and vehicle motion that is not the result of either the road surface or the actuator forces. This anomaly may result in an error in the road estimate and thereby an error in the force command which may result in poor isolation performance.

The frequency of a wheel-imbalance driven anomaly may be a function of how fast the wheel is rotating. The dominant disturbance may occur once per wheel rotation, so that if the wheel is rotating 5 times per second, the disturbance will be at 5 Hz. The rotation speed, and thus frequency of disturbance, may change as a function of vehicle speed but generally introduces content in a very narrow, sharp frequency range based on the speed.

In the distance domain, the frequency of the disturbance may effectively be constant, e.g. once per tire circumference. In some embodiments, an imbalance filter may exploit this behavior by, for example, fitting a sine wave to the input at this fixed distance-domain frequency. The sine wave phase and magnitude may be updated based on recent input. Then this fit of the imbalance may be subtracted from the input to remove its effect.

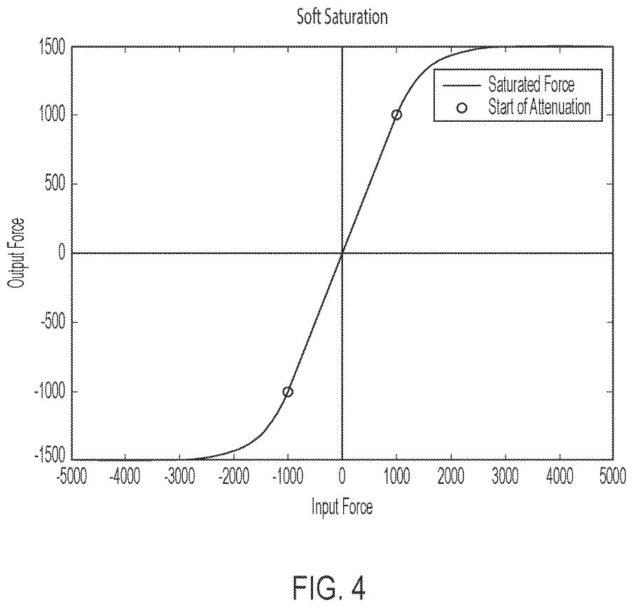

As a result of the open-loop nature of the preview controller 29, applying nonlinear effects may be safer than when using a feedback signal. Accordingly, a soft saturation may be used at block 39 that effectively limits the preview force to below a certain magnitude. For inputs below a certain magnitude (typically about 1000 N) the output may be the same as the input. Then for inputs above the lower threshold, they may be attenuated such that, for example, the output may asymptotically approach an upper limit. FIG. 4 shows an exemplary implementation of such a relationship between input and output.

In some embodiments and under certain operating conditions, the effects of the interaction between a rear wheel of a vehicle and a discrete feature, or anomalies, (such as, for example, potholes, speed bumps, manhole covers, road surface cracks, etc.) of the road surface may be mitigated by pre-energizing the rear wheel. This may allow the vehicle to prepare the rear wheel for a possible impact and to minimize the longitudinal and or vertical disturbance created by such impact. When a vehicle traveling on a road encounters or traverses a feature or an object on the road, the wheel may be compressed or extended. Due to the normal force on the wheel, any road content or feature that it traverses may result in a force being applied to the wheel that has a component in the horizontal, or longitudinal, direction in addition to the direction that is normal to the nominal surface of the road. Accordingly, the disturbance may a force that has a component either in the direction of travel of the vehicle or opposed to the direction of travel of the vehicle as well as in a direction normal to the road.

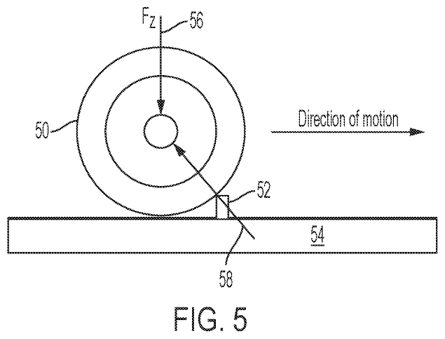

FIG. 5 illustrates a schematic a wheel 50 encountering a sharp positive road feature 52 on road surface 54. Vertical force 56 is applied to the wheel 50. This force may include the total weight and possible dynamic forces. When wheel 50 interacts with the road feature 52, the reaction force 58 applied by the road surface 54 and the road feature 52 may have a vertical component that may be equal to the total vertical force, including the vertical force 56 and inertial forces from motion of the wheel and tire itself. The reaction force 52, however, may also have a horizontal or in-plane component that depends on various characteristics of the road such as road slope and road shape; various features of the wheel such as the diameter, shape and characteristics of the tire and belt; characteristics of the suspension such as longitudinal compliance; and the vertical force applied to the tire at any given moment. The longitudinal component of force 58 may be proportional to the vertical force on the tire at the moment of or effectively at the moment of impact with feature 56.

In some embodiments, a motion state may be induced in a wheel 50 before that wheel approaches a discrete road feature 52, such that the force, e.g. longitudinal, normal, or total force, induced by the interaction between wheel 50 and road feature 52, when it occurs, is mitigated and the resulting adverse effects on the vehicle and the occupants of the vehicle are mitigated.

To establish such the desired motion state, first the characteristics of the feature and its location may be identified and/or characterized before a wheel of the vehicle interacts with the feature. In some embodiments, information about a road surface feature ahead of a vehicle may be based on prior measurements made before a wheel interacts with the feature, e.g., by using: (i) other specialized vehicles equipped with road mapping instrumentation such as laser road mapping systems; (ii) data about the feature collected during previous drives by one or more vehicles; and/or (iii) look-ahead sensors such as cameras, radar, or LiDAR to identify and characterize the feature. Alternatively or additionally, data collected during an interaction of a front wheel of a vehicle with a feature may be used to characterize the feature and establish the desired motion state of a back wheel, before that wheel interacts with the feature.

The characteristics of the feature that may be determined may include its scale (for example the height, depth, length and/or width of the event) and its location (relative to the vehicle, relative to the road surface, and/or in absolute terms). When approaching a feature, a motion plan may be prepared for a wheel of the vehicle approaching the feature. Actuators (e.g. an active suspension actuator, roll actuator, air spring actuator, or other means of moving the wheel relative to the vehicle body), may then be used to impact the movement of that wheel, prior to the interaction with the feature.

In some embodiments the normal force on the tire at the time when the wheel encounters the feature may be reduced, thus mitigating the impact (e.g. longitudinal, normal, total) that that may be transmitted to the wheel or the body. This reduction may be achieved through multiple means. In some embodiments, two roll actuators, or four actuators mounted in the corners of a four-wheeled vehicle, or at least 4 actuators mounted on at least 4 wheels of a vehicle with more than 4 wheels, or at least 2 actuators able to lift an axle on a vehicle with at least 3 axles may be used. Using such a set of actuators, an unloading of some tires may be achieved at the expense of increased loading of others, while maintaining the total supporting force on the vehicle. In some embodiments, this may be achieved by actuating one of four active suspension, air spring, or load levelling actuators, mounted at or in close proximity of each corner and attached to one wheel or unsprung mass of the vehicle, in a twist or warp pattern. For example, adjacent actuators may apply equal and opposite forces to their respective wheels. For example, forces may be applied at the four corners of a vehicle with four wheels where the left front actuator may apply a positive force, such that the right front applies a negative force of the same magnitude, the left rear applies a negative force, and the right rear applies a positive force. This may result in an unloading of the right front and left rear wheels (if the convention is that a positive force increases loading on the wheel) while supporting the vehicle by increasing loading on the left front and right rear wheels. In another embodiment, a similar effect can be achieved by actuating two roll actuators mounted each to one axle of a vehicle with two axles in such a manner that one actuator creates a roll moment to the left, while the other creates an equal and opposite roll moment to the right.

Alternatively, instead of applying the twist pattern of forces, in some embodiments, an unloading of a wheel about to interact with a feature may be achieved dynamically. The target wheel may be accelerated to change its inertial force and the direction of that force. Inventors have recognized that tires typically behave as lightly damped springs in the vertical direction, and, therefore, in combination with masses moving together with the wheel (often termed “unsprung mass”), form a lightly damped resonant second-order system. An actuator may be used to repeatedly apply a force in an appropriate pattern to excite the resonance of the unsprung mass on the tire, thus using the amplification provided by the resonant behavior of the dynamic system to create more motion, and thus induce a properly timed unloading of the wheel.

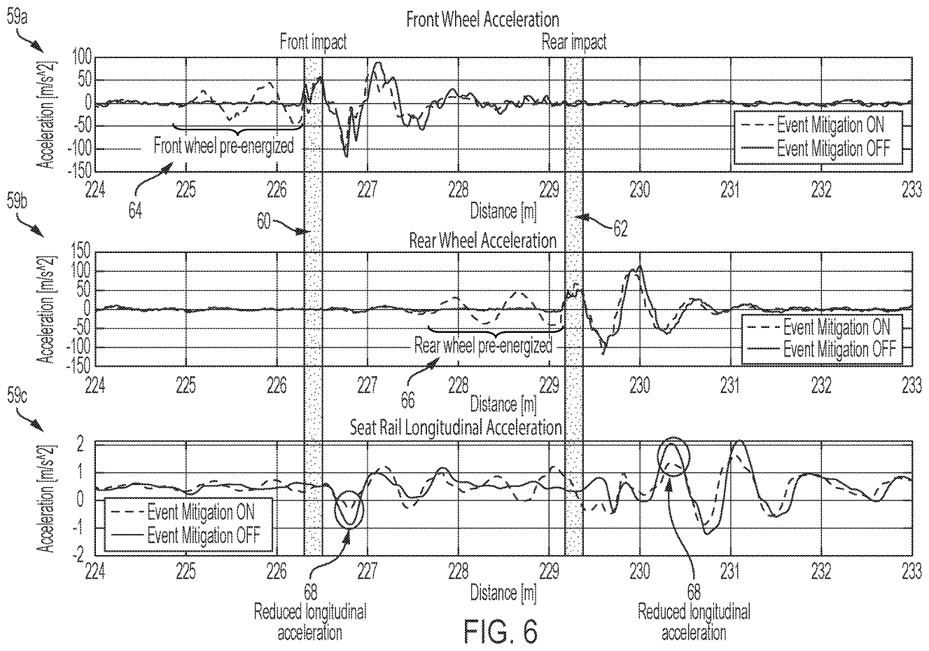

FIG. 6 shows time traces of the vertical acceleration of the front wheel of a vehicle in the top plot 59a, the vertical acceleration of the rear wheel of the same vehicle in the middle plot 59b, and the longitudinal acceleration of the chassis of the vehicle in the bottom plot 59c. At time 60, the front wheel traverses a feature, and at time 62 the rear wheel traverses the same feature. During time period 64, the front actuator may be used to energize the front wheel in a repeated pattern matching the resonant frequency of the front unsprung mass on the front tire and timed such that the wheel is at its minimum acceleration (and thus at its maximum height relative to the road surface and most unloaded) at time 60. Similarly, during time period 66 the rear wheel on the same vehicle may be energized by an actuator creating force in a pattern to excite the resonance of the rear unsprung mass on the rear tire and timed such that at time 62 the wheel is at its minimum acceleration and thus maximum height relative to the road surface, thus unloading the rear wheel when it traverses the event at 62. As can be observed from highlighted areas 68 in plot 59c, the longitudinal acceleration resulting from the interaction with the feature at times at 60 and 62, as measured on the vehicle chassis (in this case near the driver's seat rail mounting points) is significantly reduced through this method.

It should be noted that while this example shows a wheel being energized in a repeated pattern, other tire unloading patterns may be used, as the disclosure is not so limited. Unloading a wheel may happen in a single step, or using a pattern that is slower than the resonant frequency of the unsprung mass and tire, as this may reduce power consumption, noise and vibration, or occupant discomfort.

It is important to note that different methods described above may be used to mitigate interactions with different types of features, or in combination with other mitigation strategies such as, for example, a twist mitigation strategy. Unloading a wheel in the twist pattern allows for longer time periods of unloading and thus may be suited for larger features or conditions where the relative location of the feature is not known with sufficient precision. Mitigating the impact of the interaction between a wheel and a road surface feature by using oscillatory off-loading of the tire, as discussed above, may require more precise information about the location of one or more features but may be activated on both sides of the vehicle simultaneously, and may be suitable for symmetric events such as rail crossings, expansion joints, ridges, and other similar features.

Inventors have recognized that changing wheel loading may also change the dynamics of the interaction between a tire and the surface of a road. This behavior may be used to estimate road friction or tire grip. Because, under normal operation, a tire may be compressed by the normal force that is applied on it (due to the weight, and the dynamic motions of, the vehicle and wheels) it presents a certain reluctance to roll. This reluctance may be referred to as “rolling resistance” and may result in a drag force on the wheel. The tire may be driven or retarded by driving or braking torque applied by the propulsion system or the brakes respectively. Tires may also be pulled along by force on other parts of the vehicle, such as what is experienced by the undriven wheels (e.g. the rear wheels on a front-wheel-drive vehicle) or when the vehicle is coasting or rolling down a slope.

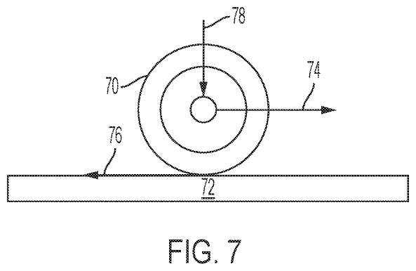

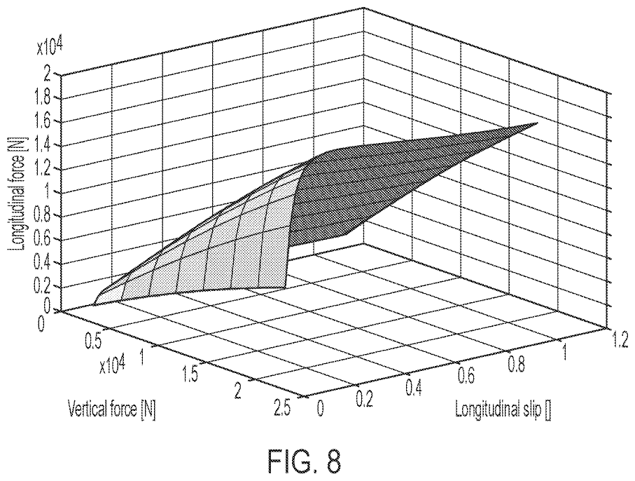

FIG. 7 shows a schematic of a wheel 70 moving along a road surface 72. A force 74 is applied to the wheel hub, for example as a reaction to a driving torque, or due to pull exerted from another wheel, and/or due to gravitational force on the vehicle. The reaction force 76 on the ground may be equal and opposite to 74. The tire 70 may support a load or vertical force 78. The ground reaction force 76 may be created through friction, and the interaction of a tire with the road surface may be characterized by a small amount of slipping, typically termed the longitudinal slip ratio. The slip ratio is a function of the loading on the tire and the longitudinal force exerted. FIG. 8 shows a typical relationship for a tire, expressed in what is often called a carpet plot, to show the relationships between longitudinal force, vertical force, and slip.

From this plot it may be determined that at any given vertical force (resulting from, e.g. the weight of the vehicle, any dynamic forces on the vehicle, and/or any additional actuator force) and any given longitudinal force (which may be determined by the traction the vehicle has at any given moment, including traction or resistance from other wheels, gravitational force, and other force pulling on the vehicle in the longitudinal direction) there is a given slip ratio the tire will experience. This slip ratio is also correlated to the friction between the tire and the surface it rests on.

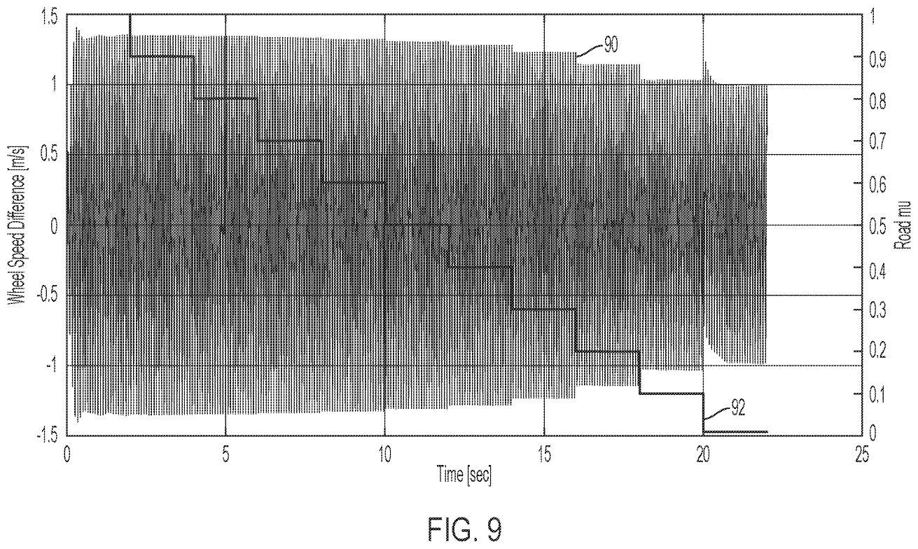

In some embodiments and under certain conditions, the surface friction may be estimated if the vertical loading for individual tires may be varied in a prescribed pattern. FIG. 9 shows a pattern 90 of repeated inputs applied to one wheel. In some embodiments, it may be advantageous to apply this pattern of force at or near the resonant frequency of the unsprung mass on the tire, to reduce the effort involved in creating a load change and thus either achieve a similar load change at a lower actuator force or achieve a higher load change at the same actuator force. However, it should be noted that other input frequency patterns may be used and the disclosure is not limited to excitations at the resonant frequency of the unsprung mass. Curve 90 shows the difference in wheel speed between a wheel on the right side and a wheel on the left side of the vehicle on the same axle, where the wheels may be loaded and unloaded in an opposite pattern to enhance the difference measured and improve the resolution of the method. It should be understood that the method may also be applied to a single wheel and the difference in speed may be compared to a reference pattern, to a wheel that is not energized, or to an average of all four wheels. On the same plot, with reference to the right-side axis, curve 92 shows the surface friction simulated for this simulation run. For simplicity, the surface friction for the simulation was stipulated to be stepping down gradually from a value of 1 to near zero in regular increments, thus allowing a single simulation run to show the entire curve. It can be seen from the curve that on roads with higher surface friction the difference in wheel speeds between right and left side of the vehicle is larger because the tires will have more grip and less longitudinal slip.

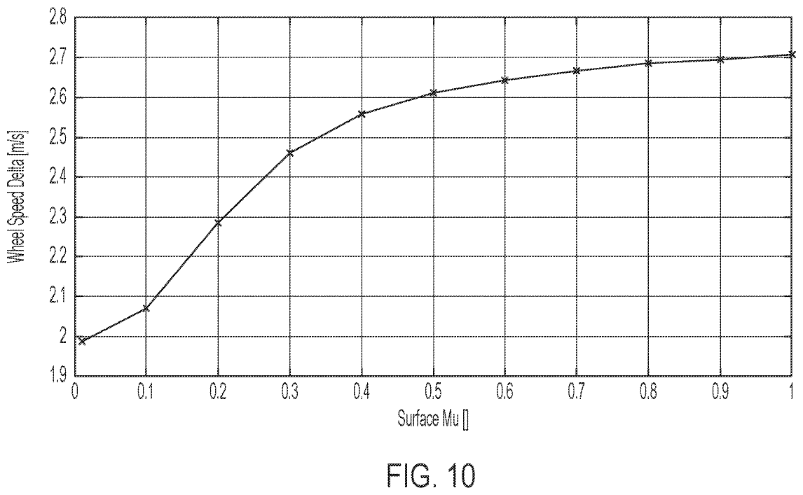

FIG. 10 shows this relationship by comparing the surface friction to the measured difference in wheel speed between the left and right side of the vehicle. The curve shows a clear correlation between the two values, thus allowing for an algorithm that extracts an unknown surface friction value based on wheel speeds while the wheels are being energized in the prescribed manner.

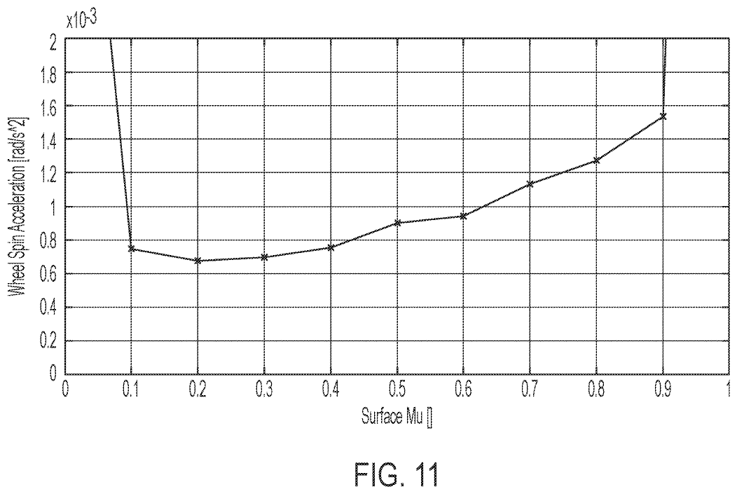

In another embodiment, a slowly changing force may be applied to all four wheels in a 4-wheeled vehicle in a warp pattern as discussed above. In this case, a change in surface friction may cause a change in wheel spin acceleration that may be more easily discerned than the change in wheel speed and may thus be used to estimate surface friction. FIG. 11 shows the relationship between the measured wheel spin acceleration and the surface friction. This method may be preferrable in scenarios where the actuators are unable to create rapidly changing patterns of force, or in scenarios where a rapid change in tire loading is undesirable for comfort or safety reasons.

In another embodiment or under different operating conditions, other vehicle sensors may be used to detect a change when a twist force is applied. For example, a change in yaw rate that is related to the surface friction and/or tire grip may be detected, where the change cannot be attributed to either the driver or a vehicle controller. Alternatively, if there is a correction by the lane keep assist function, or by the operator, or by the steering system in response to a change in steering torque at the wheels due to the change in friction, then this signal may also be used as a metric for estimating surface friction. Therefore, when an actuator force is applied in a warp pattern, the resulting response by the steering system, operator, or driver assist function may be measured, and the surface friction may be estimated based on the measurements.

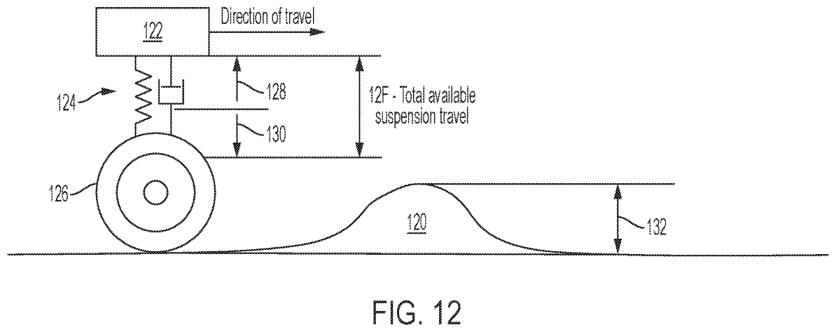

FIG. 12 shows a schematic of a vehicle approaching a positive road feature 120, such as for example a speedbump. A positive road feature, as used herein refers to a road feature that substantially protrudes in the direction of the vehicle or has a portion that protrudes in the direction of a vehicle. Positive road features may include but are not limited to raised bumps, speedbumps, railroad crossings, steps, curbs, road plates, and frost heaves. As used herein, a negative road feature refers to a feature that substantially falls away from the vehicle. Such features may include but are not limited to potholes, step-downs, dips, sinkholes, and storm drains covers.

FIG. 12 shows a vehicle with vehicle body 122, suspension system 124, and wheel and tire 126 approaching feature 120. The vehicle is represented as having a single wheel but may include a multiplicity of wheels. As a wheel approaches the road feature 120 or other obstacle, it may be exposed to multiple forces. In some embodiments and under certain conditions, the wheel and tire 126 may support vehicle's weight and dynamic loading. The road surface may apply a reaction force on the tire that is at an angle that is correlated with the slope of the road. Where the road is rising (meaning when the road inclination has a component that opposes the direction of motion of the vehicle with respect to the vertical axis of the vehicle), the reaction force on the wheel and tire may push the vehicle backwards and where the road has a downward slope (meaning when the road inclination has a component that is aligned with and in the same direction of the direction of motion of the vehicle), the reaction force on the wheel and tire may push the vehicle forward.

A suspension system may be used to reduce motion of the vehicle body and to increase comfort for the occupant(s). To achieve this, the suspension may change length when traversing road obstacles. For example the suspension may be compressed when traversing a positive feature in order to absorb at least part of the body motion that would otherwise be induced by the feature. However, suspension systems have a limited range of travel. The extent to which a suspension system can be compressed or extended is limited. The suspension system illustrated in FIG. 12 has a maximum available compression travel 128, and a maximum extension travel 130.

When traversing a feature with a height 132, the suspension may be able to absorb the effects of the feature entirely or effectively entirely, for example, if height 132 is less than maximum available compression travel 128. However, if the feature height 132 is larger than the available compression travel 128, then the vehicle may not be able to fully absorb the event without exceeding its travel limits. This may induce significant increase in normal force on the tire. This increase may be perceived by the occupants as a significant disturbance and may be undesirable.

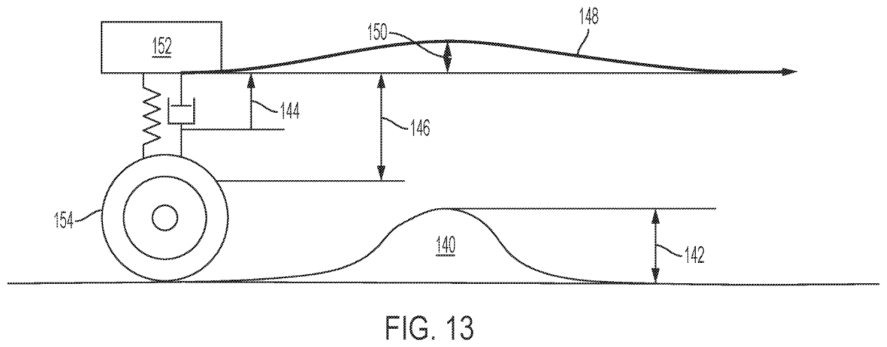

FIG. 13 illustrates how the suspension system may be adjust is anticipation of an interaction with a feature 140 that has a maximum height 142 that exceeds the maximum available compression travel 144 of the suspension but not the maximum total travel 146. A trajectory 148 for the vehicle may be planned that elevates the vehicle to a maximum trajectory height of 150. In some embodiments and under certain operating conditions, where the feature height 142 is greater than the available compression travel 144 but less than total available travel 146, the maximum trajectory height of 150 may be equal to zero.

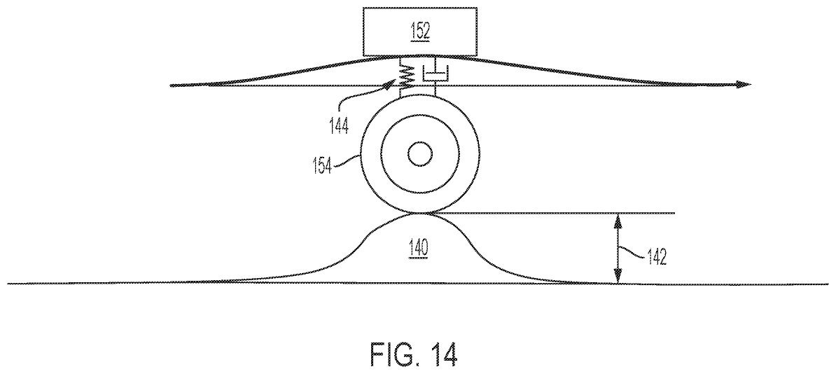

In some embodiments under certain operating conditions, the suspension system may be configured to follow a planned trajectory, and may be able to achieve this trajectory without substantially deviating from it, then at the maximum height over the event, as shown in FIG. 14, the vehicle body 152 may be at or near its trajectory height above its original position, while the wheel 154 follows the road and suspension 144 is compressed by an amount that does not exceed its maximum available compression travel.

This may achieved by reducing the amount of tire force variation while the wheel traverses the road feature. Tire force is given by the sum of the portion of the weight of the vehicle that rests on the specific wheel, plus the reaction forces due to acceleration of the wheel and vehicle body. Under the simplifying assumption that the wheel follows the road event, the only remaining variable is the acceleration of the vehicle body. Acceleration of the vehicle body to in the vertical direction may increase the force that the tire is exposed to, while pre-emptively and gradually accelerating the vehicle body prior to the interaction with the feature may reduce any change in tire force as a result of the interaction. Thus, the optimal solution for trajectory 148 may be determined by minimizing the acceleration on the vehicle body under the constraint provided by the maximum available suspension travel, the maximum available compression travel, and the road event height as described above.

Planning a trajectory such as the one described above may require advance knowledge of the upcoming road, which may be based on local sensors or from other sources of prior knowledge. It may require a suspension actuator able to modify the position of the vehicle body with respect to the ground within a time frame suitable for responding effectively to road feature interactions. A suitable time frame may depend on the shape of the road and the vehicle speed. On a generally flat road with a single positive event, a slow actuator with sufficient warning may be able to raise the car over a long period of time and still be ready for the event. However, most roads have more than a single event and an actuator may need to change trajectory after one event and be ready for the next one. It may be preferrable to be able to move the car within one second to perform this function on most roads, but a slower or faster actuators may still benefit from this method, as the present disclosure is not limited in this respect.

It should be understood that in the discussion above, the available travel may be less than the travel that a suspension may sustain without hitting hard (physical) or soft limits or exceeding its design specification. The available travel limit may be adjustable, dependent on operating conditions, or set by the designer or a controller. It may be set to achieve a desired comfort, safety, or drivability target, or to match a maximum desired force output from an actuator.

In another aspect of the invention, a vehicle may encounter a single-sided negative feature. The vehicle may be alerted to the presence of such a feature by one of the methods described above, for example based on data collected during a previous drive, data from a different vehicle or vehicles, data from a characterized road segment, data transmitted from the cloud, data stored on the vehicle, or any other such method.

As the vehicle approaches the feature, a time to the expected encounter with the event may be calculated, using the current location of the vehicle with respect to the feature, the location of the feature, and/or the current vehicle speed. This calculation may be performed on the vehicle, or offline in the cloud before the vehicle approaches the feature. If the vehicle changes speed during the period of time between when the calculation is made, and when the vehicle encounters the feature, the expected time may be re-calculated and a new expected time may be used if appropriate.

Inventors have recognized that the discomfort to the occupants, and the potential for damage of vehicle components, that arises from encountering a negative event in the road, such as for example a pothole, is correlated with the amount of normal force on the tire that encounters the feature. This is a result of the wheel and tire having to conform to the road contour due to the normal force acting on the tire. This force may consist of the portion of the vehicle's weight supported by the particular tire, along with any variations caused by the dynamic loading of the wheel or the vehicle body.

In some embodiments and under certain operating conditions, an active suspension or active roll system may be used to lessen the normal force on the tire that is expected to encounter the negative event. This may be achieved by applying a force in a twist, or warp, pattern such that the suspension actuators increase the force on two opposing tires, while increasing the normal force on the other two, one of which may interact with the negative feature.

In some embodiments, three factors may be considered when calculating the time when the force should be applied. First, the actuation system may have a response time that requires a force command to be give sufficiently in advance to achieve the desired force level at appropriate time. Second, there may be a limited accuracy in either the estimated location of the vehicle, or the estimated location of the feature. In this case, it may be desirable to apply the force command in advance to compensate for the possible error. Third, a rapid force application may have adverse effects on perceived comfort or NVH (noise vibration and harshness) by the occupants, and force may therefore need to be applied more gradually. Taking into account whichever of these are relevant for a given situation and actuator to be used, along with other possible timing considerations related to processing speed, update rate of the processor, or similar, the appropriate timing for a force command to the actuator system may be determined in order to achieve the desired wheel unloading at the moment the vehicle encounters the feature.

When encountering a feature that is on one side of the vehicle, it is also important to consider the fact that the feature will first be encountered by the front wheel on one side of the vehicle, and shortly thereafter may be encountered by the rear wheel on the same side of the vehicle. For many road vehicles, the front and rear wheels follow a similar path during most normal driving other than during slow parking lot maneuvers or situations where the vehicle slides sideways (has a significant sideslip angle). Most road vehicles also have similar front and rear track widths, meaning the front and rear wheels of a vehicle may have the same lateral spacing with respect to the vehicle chassis and thus may follow the same path over a road surface. For vehicles or driving situations where either the front and rear wheels do not follow the same path, the application of event mitigation strategies discussed here may be done independently on the front and rear. For vehicles however where the front and rear wheels follow the same path or substantially or effectively the same path, for example, to within a lateral offset of less than 1 cm, or less than 5 cm, or less than 10 cm, the timing between the front and rear event may be noted. This time will decrease with increasing vehicle speed and is related to the wheelbase of the vehicle (the distance between front and rear wheels along the direction of travel of the vehicle). Using similar considerations as described above for the front wheel, for example taking into account the particular actuation system used on the rear wheel about to encounter the event, the delays inherent to such actuation, the NVH and comfort effects of rapid force application, and/or other considerations, the optimal time of application of force to the rear wheel may be determined.

In certain embodiments and under certain operating conditions, a twist force strategy may be implemented by unloading the front wheel and loading the rear wheel on the same side of the vehicle. After the front wheel interacts with a road surface, the front wheel may be loaded while the rear wheel is unloaded. Therefore, a twist strategy may be effective, at a given speed, if there is sufficient time to perform this switch.

A behavioral planning control method is beneficial when considering the mitigation strategy to apply for a given event, driving scenario, speed, user setting, and considering other vehicle states or user preferences as desired. This behavioral planner control method may take the information about the type, characteristics, and location of an upcoming event, calculate the optimal timing for wheel unloading commands, decide on the optimal strategy given those timing requirements, and then communicate this decision to downstream control methods that calculate and apply the optimal force command to achieve the desired effect. The decision made by the behavioral planning control method may include optionally deciding to apply twist force, deciding to apply other unloading methods, or deciding to not apply any mitigation strategies, or subsets or combinations of those, or it may include deciding the amount of mitigation to apply in each case.

FIG. 15. illustrates a vehicle 210. The vehicle includes a vehicle body 212 that supports the various components of the vehicle. As shown in FIG. 15, the vehicle includes a microprocessor system 214, with one or more microprocessors, which may communicate with various subsystems via a communication channel 216. It is noted that in FIG. 15, although the microprocessor system 214 is shown as a single unit, it may include multiple microprocessors located in multiple locations in the vehicle, as the present disclosure is not limited in this respect. As shown in FIG. 15, the vehicle may include an active suspension system, with active suspension actuators 218, that is operatively interposed between a wheel 220 (or the wheel assembly, of an unsprung mass) of the vehicle and the vehicle body 212 (e.g., sprung mass). In particular, active suspension actuators 218 may be operatively interposed between each wheel of the vehicle and the vehicle body 212, such that separate actuators of the active suspension may independently control the vertical motion of individual wheels of the vehicle. Each actuator 218 may be configured to apply force between the wheels 220 and the vehicle body 212. The actuators 218 may affect a motion response of the body 212, and in particular one or more vehicle motion characteristics. The vehicle may also include a braking system with brakes 222. The braking system may include independent brakes coupled to each of the vehicle wheels 220, such that a braking force may be applied to each wheel independently. According to the embodiment illustrated in FIG. 15, the vehicle may also include a forward-looking sensors 223, and/or other motion sensors 223a (e.g. inertial motion sensors (IMUs), displacement sensors, accelerometers, etc.). The forward-looking sensors may include, for example, one or more cameras, LIDAR, radar, a combination thereof, may be configured to sense forward-looking road information that may be employed by one or more vehicle planners or controllers which may be located in the microprocessor system 214. Alternatively or additionally, previously collected (e.g. crowd sourced) forward-looking road information may be received, at one or more microprocessors in microprocessor system 214, from one or more local (i.e. on-board) or remote databases. Motion sensors 223a may be used to provide information about the motion of various portions of the vehicle (e.g. the vehicle body, a wheel assembly, an active suspension actuator) to one or more microprocessors in the microprocessor system 214.

According to the embodiment of FIG. 15, the vehicle may also include a steering system 224 including, in the case of a driven vehicle, a steering wheel 224a. The steering wheel 224a may form a part of a user interface of vehicle 210. The user interface may be used to provide user input to control various portions of the vehicle or to provide feedback, e.g. tactile feedback, to a user. In some embodiments, the steering system 224 may include a rear steering system configured to control one or more rear wheels of the vehicle. Other user interfaces may also be used as the present disclosure is not limited in this respect.

As shown in FIG. 15, the vehicle may traverse over road 226. As illustrated in FIG. 15, the road may include a plane of the road surface 228. As used herein, the term “vehicle body” refers to the sprung mass of a vehicle irrespective of the type of body construction and includes but is not limited to: unitary, unibody, or monocoque vehicle body constructions; vehicle bodies including a separately formed vehicle chassis attached to the other portions of the vehicle body; and/or any other type of vehicle body construction that functions as a sprung mass that is supported by a suspension system of a vehicle.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

The above-described embodiments of the technology described herein may be implemented in any of numerous ways. For example, the embodiments may be implemented using hardware, software or a combination thereof. When implemented in software, the software code may be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format. It should also be understood that any reference to a controller in the current disclosure may be understood to reference the use of one or more processors configured to implement the one or more methods disclosed herein.

Further, it should be appreciated that a computing device including one or more processors may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices may be used, among other things, to present a user interface. Examples of output devices that may be used to provide a user interface include display screens for visual presentation of output and speakers or other sound generating devices for audible presentation of output. Examples of input devices that may be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks. Also, the various methods or processes outlined herein may be coded as software that is executable on one or more processors that employ any one of a variety of operating systems or platforms. These methods may be embodied as processor executable instructions stored on associated non-transitory computer readable media that when executed by the one or more processors perform any of the methods disclosed herein. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media may be transportable, such that the program or programs stored thereon may be loaded onto one or more different computing devices or other processors to implement various aspects of the present disclosure as discussed above. As used herein, the term “computer-readable storage medium” encompasses only a non-transitory computer-readable medium that may be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that may be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A method of operating a vehicle, the method comprising:
during a first interaction, interacting with a negative road feature with a first wheel of the vehicle;
during the first interaction, receiving data from at least one sensor on-board the vehicle;
based on the data, determining a characteristic of the negative road feature;
based on the characteristic, developing a second-wheel control strategy to minimize an amount of penetration into the negative road feature with a second wheel of the vehicle;
during a second interaction, interacting with the negative road feature with the second wheel of the vehicle; and
during the second interaction, implementing the second-wheel control strategy.

2. The method according to claim 1, wherein the negative road feature is a pothole.

3. A method as in claim 2, wherein the characteristic of the negative road feature is selected from the group consisting of a length of the pothole and a depth of the pothole, a sharpness of an edge of the pothole, and a width of the pothole.

4. A method as in claim 1, wherein the second-wheel control strategy includes use of a system selected from the group consisting of an active suspension system, a semi-active suspension system, a steering system, and a braking system.

5. A method as in claim 1, wherein the second-wheel control strategy depends at least partially on a value of a state parameter of the vehicle.

6. The method according to claim 5, wherein the state parameter is a speed of the vehicle.

7. A method as in claim 1, wherein the vehicle further includes a third wheel and a fourth wheel, and wherein the second-wheel control strategy includes initiating a warp vertical wheel force pattern among the four wheels.

8. A method as in claim 1, wherein the second-wheel control strategy includes bouncing the second wheel at a predetermined frequency.

9. The method according to claim 8, wherein the predetermined frequency is a wheel-hop frequency of the second wheel.

10. A method as in claim 1, wherein the first wheel and the second wheel are a front wheel and a rear wheel of the vehicle, respectively.

11. A method of operating a first vehicle, the method comprising:
from a second vehicle, receiving information about a first interaction between a wheel of the second vehicle, traveling ahead of the first vehicle, and a negative road feature;
based on the information, determining a characteristic of the negative road feature;
based on the characteristic, developing a wheel control strategy to minimize an amount of penetration into the negative road feature with a wheel of the first vehicle;
during a second interaction, interacting with the negative road feature with the wheel of the first vehicle; and
during the second interaction, implementing the wheel control strategy.

12. The method according to claim 11, wherein the first vehicle and the second vehicle are traveling at a first speed and a second speed, respectively, wherein a difference between the first speed and the second speed is less than ten miles per hour.

13. A method as in claim 11, wherein the negative road feature is a pothole.

14. A method as in claim 13, wherein the characteristic of the negative road feature is selected from the group consisting of a length of the pothole, a depth of the pothole, a sharpness of an edge of the pothole, and a width of the pothole.

15. A method as in claim 11, wherein the wheel control strategy includes use of a system selected from the group consisting of an active suspension system, a semi-active suspension system, a steering system, and a braking system.

16. A method as in claim 11, wherein the wheel control strategy depends at least partially on a value of a state parameter of the first vehicle.

17. The method according to claim 16, wherein the state parameter is a speed of the first vehicle.

18. A method as in claim 11, wherein the first vehicle includes a total of four wheels, and wherein the wheel control strategy includes initiating a warp vertical wheel force pattern among the four wheels.

19. A method as in claim 11, wherein the wheel control strategy includes bouncing the wheel of the first vehicle at a predetermined frequency.

20. The method according to claim 19, wherein the predetermined frequency is a wheel-hop frequency of a second wheel of the first vehicle.

21-30. (canceled)
